(19) United States
(12) Patent Application Publication
(10) Pub. No.: US 2026/0320067 A1
(43) Pub. Date: Oct. 15, 2026

(54) LARGE LANGUAGE MODEL DRIVEN SYSTEMS AND METHODS FOR GENERATING STRUCTURED DATA BASED ON NETWORK DEVICE COMMANDS FOR AUTOMATION

(71) Applicant: JPMorgan Chase Bank, N.A., New York, NY (US)

(72) Inventors: David Algorry, CABA (AR); Joel Guest, Conroe, TX (US); Gaston Liberman, Buenos Aires (AR); Najah Ghalyan, Wayne, NJ (US); Sean Moran, London (GB); Rozie Tereza Yeghiazarian, Jersey City, NJ (US)

(73) Assignee: JPMorgan Chase Bank, N.A., New York, NY (US)

(21) Appl. No.: 19/176,410

(22) Filed: Apr. 11, 2025

(51) Int. Cl. G06F 16/25; G06N 3/0475

(52) U.S. Cl. CPC G06F 16/258; G06N 3/0475

(57) ABSTRACT

Aspects of the subject disclosure may include, for example, a method for converting unstructured network device command outputs into structured data using a universal parser. The method includes extracting raw data from a data storage, followed by filtering the extracted raw data using a topic model algorithm, and using a large language model (LLM), extracting fields from filtered data and generating a universal parser. Other embodiments are disclosed.

### FIELD OF THE DISCLOSURE

The subject disclosure relates to large language model driven systems and methods for generating structured data based on network device commands for automation.

### BACKGROUND

Parsing network device commands has involved manually creating individual parsers in connection with network device commands. Different network devices may use different commands and for a single network command, different parsers can be prepared by different users. Accordingly, the process of manually creating individual parsers, considering a large number of network devices using different commands, can be significantly time-consuming, labor-intensive and prone to errors. Network technician often spend significant amount of time creating and maintaining these parsers to manage network configurations, perform audits, and troubleshoot issues. This manual effort may not only reduces productivity but also may increase the likelihood of inaccuracies and inconsistences in network management tasks.

### SUMMARY OF THE DISCLOSURE

The subject disclosure describes, among other things, illustrative embodiments of large language model (LLM) driven systems and methods for generating structured data based on network device commands for automation. The systems and methods utilize an LLM model that generates a universal parser from a single network device command for different network devices. The LLM model can handle different commands and automatically generates the universal parser for parsing a network device command output using a TextFSM function. By developing the universal parser, a parsing process can be automated, thereby generating structured data based on raw data such as network device command outputs. This may result in streamlining network management tasks, improving accuracy, and enhancing operational efficiency. The universal parser will serve as a foundation tool that can be extended to other network commands, providing a scalable solution for network configuration and management. Other embodiments are described in the subject disclosure.

One or more aspects of the subject disclosure include a non-transitory machine-readable medium, comprising executable instructions that, when executed by a client computing device including a processor, facilitate performance of operations. The operations can comprise extracting raw data from a data storage, wherein the raw data include a plurality of network device command outputs for a target network device command for different network devices; filtering the raw data using a topic model algorithm; extracting a plurality of fields using a generative artificial intelligence (Gen-AI) engine from the filtered raw data; classifying the extracted plurality of fields into a first classification and a second classification, where the first classification corresponds to a simple field and the second classification corresponds to a complex field; using the Gen-AI engine, generating, an one field parser for the simple field and merging every one field parser, resulting in a merged single field parser; using the Gen-AI engine, generating complex parsers configured to parse the complex field; outputting an universal parser based on the merged single field parser and the complex parsers; and using the universal parser, generating structured data from the raw data to be used in a network process by the different network devices.

One or more aspects of the subject disclosure are directed to a method. The method can comprise extracting, by a processing system including a processor, textual data from a data storage, where the textual data includes include a plurality of network device command outputs for a selected network device command with respect to different network devices; filtering, by the processing system, the textual data using a topic model component to organize and categorize the textual data based on specific topics; extracting, by the processing system, a plurality of fields from the filtered textual data using a generative artificial intelligence (Gen-AI) engine; classifying, by the processing system, the extracted plurality of fields into a simple field and a complex field; generating, by the processing system, a simple parser for the simple field using the Gen-AI engine; generating, by the processing system, a complex parser for the complex field; and generating, by the processing system, a universal parser by combining the simple parser and the complex parser for use in a network process by network devices.

One or more aspects of the subject disclosure are directed to a system comprising a processing system including a processor and a memory that stores executable instructions that, when executed by the processing, facilitate performance of operations. The operations can comprise extracting raw data from a data storage, wherein the raw data include a plurality of network device command outputs for a target command with respect to different network devices; filtering the raw data using a topic model algorithm; extracting a plurality of fields using a generative artificial intelligence (Gen-AI) engine from the filtered raw data; classifying the extracted plurality of fields into a first classification and a second classification, where the first classification corresponds to a simple field and the second classification corresponds to a complex field; using the Gen-AI engine, generating, an one field parser for the simple field and merging every one field parser, resulting in a merged single field parser; using the Gen-AI engine, generating a complex parser configured to parse the complex field; outputting an universal parser based on the merged single field parser and the complex parser; and using the universal parser, generating structured data by converting the raw data for use in the network process by the different network devices.

### BRIEF DESCRIPTION OF THE DRAWINGS

Reference will now be made to the accompanying drawings, which are not necessarily drawn to scale, and wherein:

FIG. 1 is a block diagram illustrating example, non-limiting embodiments of a system for generating structured data from a network command output using a universal parser in accordance with various aspects described herein.

FIG. 2 depicts a non-limiting example of raw data and processed data in accordance with various aspects described herein.

FIG. 3 depict non-limiting examples of topic models in accordance with various aspects described herein.

FIG. 4 illustrates example, non-limiting embodiments of simple parsers in accordance with various aspects described herein.

FIG. 5 illustrates example, non-limiting embodiments of complex fields in accordance with various aspects described herein.

FIG. 6A illustrates example, non-limiting embodiments of a universal parser in accordance with various aspects described herein.

FIG. 6B illustrates example, non-limiting embodiments of another universal parser in accordance with various aspects described herein.

FIG. 7A illustrates example, non-limiting embodiments of parsing with a universal parser in accordance with various aspects described herein.

FIG. 7B illustrates example, non-limiting embodiments of another parsing with a universal parser in accordance with various aspects described herein.

FIG. 8 illustrates a non-limiting embodiment of a method in accordance with various aspects described herein.

FIG. 9 is a block diagram of an example, non-limiting embodiment of a computing environment in accordance with various aspects described herein.

### DETAILED DESCRIPTION

The subject disclosure describes, among other things, illustrative embodiments of large language model driven systems and methods for generating structured data based on network device commands for automation. The systems and methods utilize an LLM-based algorithm that generates a universal parser from network commands for different network devices. The LLM-based algorithm can handle different commands and automatically generates the universal parser for a target network device command using a TextFSM function. By developing the universal parser, a parsing process can be automated, thereby streamlining network management tasks, improving accuracy, and enhancing operational efficiency. The universal parser will serve as a foundation tool that can be extended to other network commands, providing a scalable solution for network configuration and management. Other embodiments are described in the subject disclosure.

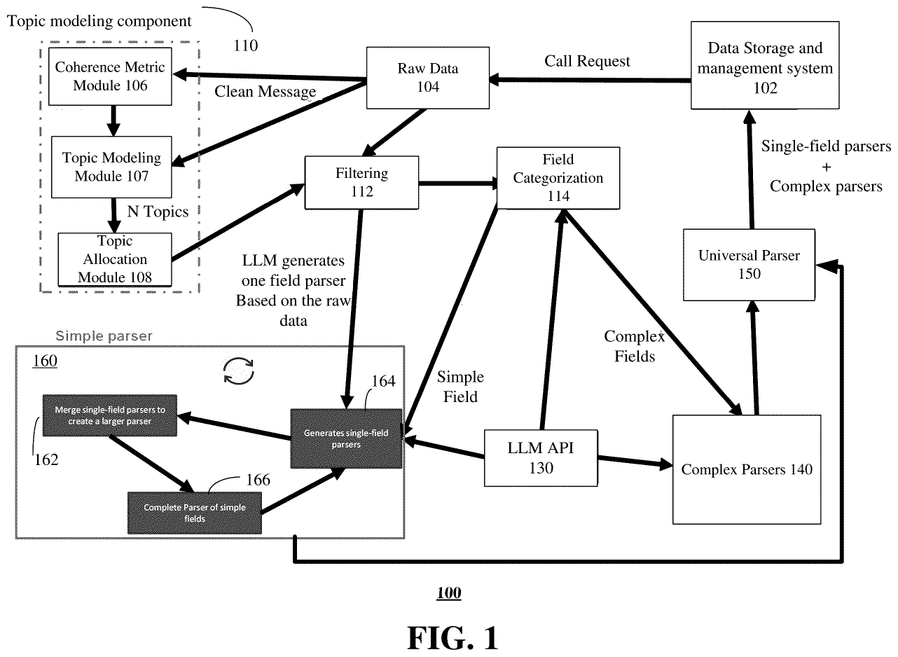

FIG. 1 is a block diagram illustrating example, non-limiting embodiments of a system 100 for generating structured data from a network command output using a universal parser in accordance with various aspects described herein. The system 100 is directed to developing a universal parser for parsing network device command outputs. Parsing is a process of breaking down a complex set of data or code into smaller, more manageable components. Parsing is to analyze and interpret the syntax of the code to extract relevant information. Parsing is a key component of many applications that need to process structured input. As one example, data parsing includes converting data from one format to another. As another example, data parsing facilitates making unstructured data more readable and comprehensible. The system 100 operates to parse network device command outputs from various network devices with the universal parser and convert the network device command outputs into a structured format for automation and further processing.

In various embodiments, the system 100 is configured to use TextFSM, significantly automating the parsing process to enhance productivity and accuracy in network management tasks. TextFSM is a Python library used for parsing command-line interface (CLI) outputs. TextFSM is useful for extracting information from command-line interface (CLI) outputs, which are often presented in a text format that is not suited for automation. TextFSM uses a template-based approach to define the structure of the text to be parsed, allowing users to specify patterns and rules for extracting relevant data fields. TextFSM is used to parse data from network devices and provides a systematic way to convert raw text into structured data, making it easier to manage and use within various network automation tasks. Using TextFSM to convert raw data to structured output is particularly useful in situations where other APIs may not provide required data in a structured format. For instance, REST API may not support retrieving data for specific queries. With TextFSM, templates for the output of legacy CLI commands can be generated, offering a significant amount of flexibility.

The system 100 is further configured to leverage advanced AI/ML techniques, to generate the universal parser as a scalable and robust tool that can handle the complexity and variability of network device configurations. The universal parser will be applicable across various use cases such as network inventory management, topology mapping, configuration audits, troubleshooting, and automated reporting. The effectiveness of the universal parser will be evaluated using specific metrics like device coverage and field coverage, ensuring a high level of accuracy and operational efficiency, ultimately reducing manual effort required by network technicians and administrators.

In various embodiments, the system 100 uses the advanced AI/ML techniques, especially few-shot learning and the generative AI model, to automate the creation of the universal parser for network device command outputs. Few-shot learning is a machine learning approach that enables AI/ML models to generalize and learn new tasks with only a small number of training examples. Unlike traditional models that require large datasets, few-shot learning leverages prior knowledge and patterns learned from related tasks to make accurate predictions with minimal data. Unlike traditional parsers and rule-based systems that often struggle with the variability and complexity of modern network configurations, the system 100 can dynamically learn from a small number of examples and generalize across different configurations. The system 100 not only significantly reduces the manual effort required to develop and maintain parsers but also enhances accuracy and scalability. Additionally, the universal parser's ability to handle a wide range of network management tasks-such as inventory management, topology mapping, configuration audits, troubleshooting, and automated reporting may provide a comprehensive and integrated solution that exceeds current industry standards. This combination of automation, advanced AI capabilities, and broad applicability makes the universal parser an effective tool in the network configuration and management.

Referring to FIG. 1, in one or more embodiments, the system 100 includes a data storage and management system 102, raw data 104 extracted from the data storage and management system 102, and a topic modeling component 110. The topic modeling component 110 includes a coherence metric module 106, a topic modeling module 107, and a topic allocation module 108. The system 100 is configured to perform a data integration process that combines data from multiple sources into a single database or data warehouse. The system 100 facilitates cleaning and organizing raw data, and preparing for storage, data analytics, and machine learning. The system 100 also facilitates storing legacy data, and unifying it with current data to provide historical context. In the system 100, ETL (Extract, Transform, Load) pipelines can be run in parallel to save time. For example, while data is being extracted, a transformation process could be working on data already received.

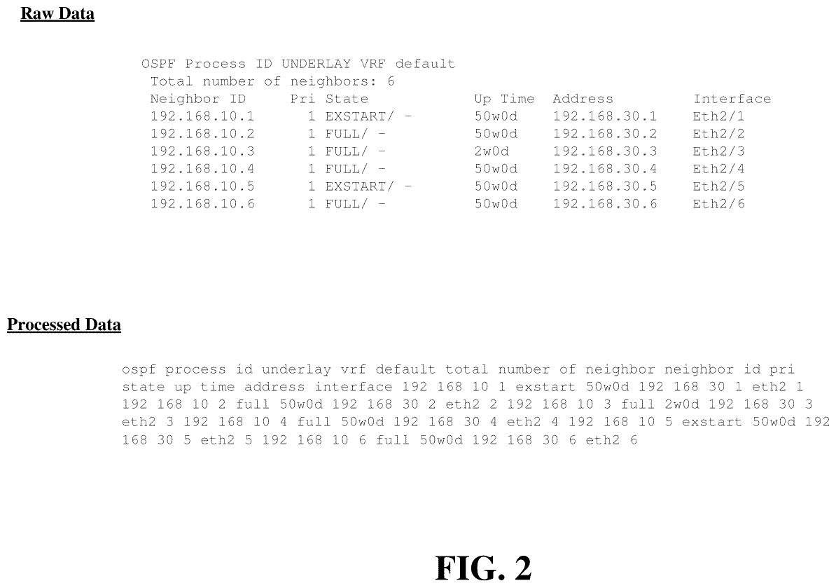

In one or more embodiments, raw data 104 for a specific network device command is extracted from the data storage and management system 102 along with parser examples provided by users. The data storage and management system 102 is configured to store the raw data 104 and also serves as a platform where the universal parser 150 is uploaded once it is validated, as shown in FIG. 1. The raw data 104 include network command outputs from various network device commands, such as “show cdp network details,” “show ip ospf neighbors vrf all,” etc. FIG. 2 illustrates a non-limiting example of the raw data 104 in accordance with various embodiments herein. To extract the raw data 104, an authenticated application programming interface (API) session is used to extract or retrieve outputs of network device commands from the data storage and management system 102. The extracting process involves setting up authentication, initializing a session, and making API requests to obtain data.

Parser examples are provided by users and stored in the data storage and management system 102. Parser examples are used for creating topic models, which in turn are used to generate the universal parser. Parser examples are applied to the raw data 104 to parse and convert the raw data 04 in a more structured format. By way of example only, a parser example provided by users, for “show ip ospf neighbors vrf all” command, follows:

Value ospf_neighbor (\S+)
Value state (\w+)
Value ospf_neighbor_ip (\S+)
Value interface (\S+)
Start
\hat{ }\s+${ospf_neighbor}\s+\d+\s+${state}\S+\s+\S+\s+\S+\s+${ospf_neighbor_ip}\
s+${interface} -> Record

These parser examples are scraped with an API call and used in the pipeline. Using API requests, the raw data 104, such as the network device command outputs, are programmatically retrieved from the data storage and management system 102. The API call accesses the stored data, fetching specific network command outputs needed for further processing. Once retrieved, specific network device command outputs are fed into a processing pipeline. The processing pipeline includes various steps such as cleaning, preprocessing, and parsing of the retrieved specific command outputs to develop the universal parser 116. The processing pipeline may automate transformation of the raw data 104 into structured formats for analysis and parser generation. FIG. 2 illustrates a non-limiting example depicting raw data and processed data in accordance with various embodiments herein. The raw data is unstructured and includes network device information such as Device ID, address(es), Platform, Interface, version, etc. As a result of processing in the pipeline, processed data can be generated as depicted in FIG. 2.

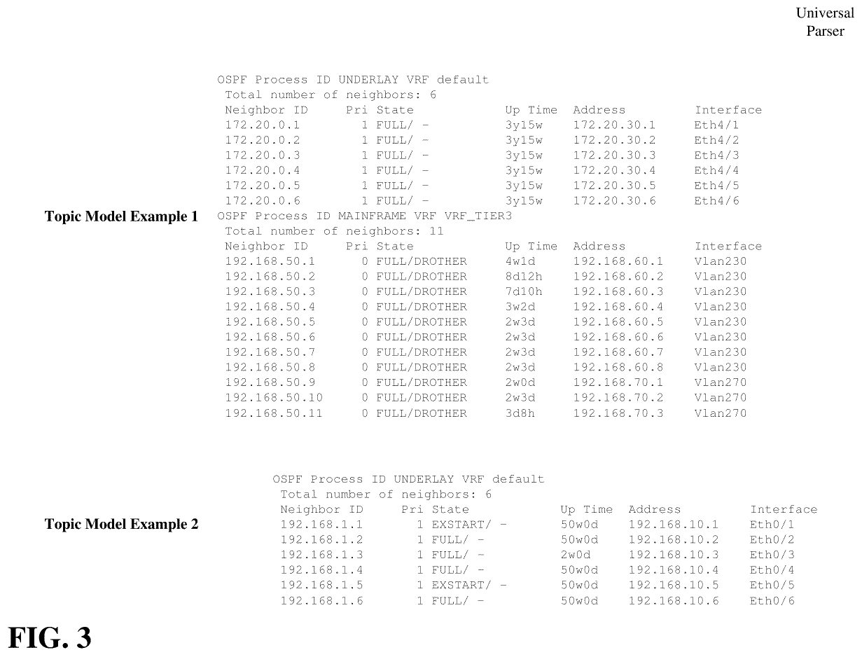

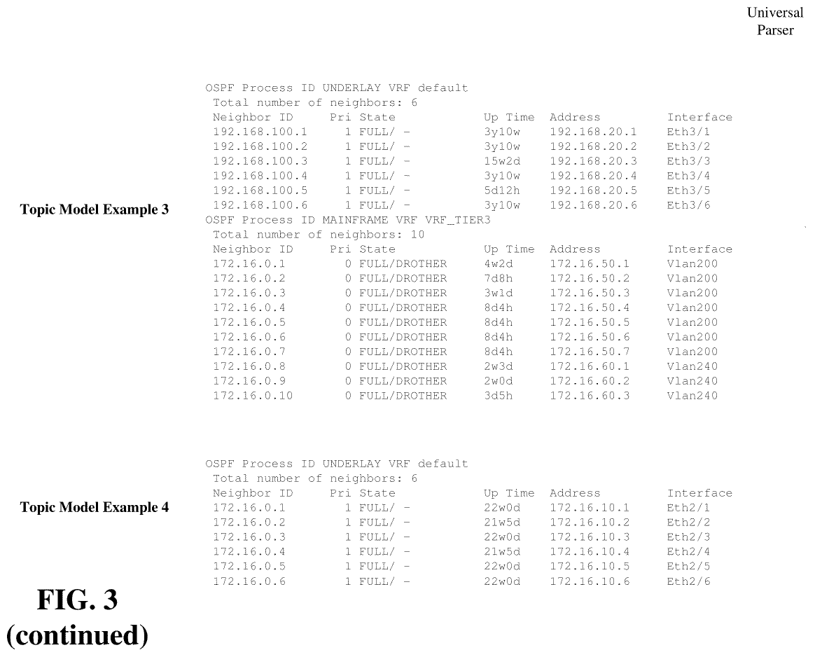

In various embodiments, referring back to FIG. 1, due to a vast amount of the raw data 104, a topic model process is used to filter the raw data 104, as shown in the topic modeling component 110. The raw data 104 is a textual dataset which is decomposed into topics and words. The textual dataset includes several topics and each topic is composed of a collection of words. FIG. 3 illustrates non-limiting examples of topic model examples 1 through 4. Each topic model example depicted in FIG. 3 depicts several topic models from the raw data 104 by way of example only. The separation of the topic model examples into those with one table (Examples 2 and 4) and those with two tables (Examples 1 and 3) likely serves to illustrate the parser's versatility in handling different complexities of data.
Examples 1 and 3: These include two tables, each representing different OSPF process IDs and VRFs. This setup demonstrates the parser's ability to manage and extract structured data from more complex scenarios involving multiple sets of information within a single dataset. There are two similar topics, as the idea is to filter data based on repetition, allowing for the identification of common patterns and themes.
Examples 2 and 4: These contain only one table, focusing on a single OSPF process ID and VRF. These examples highlight the parser's efficiency in processing simpler datasets while maintaining consistency in data extraction.

By presenting both single and multiple table scenarios, the examples show the parser's adaptability to varying data complexities, ensuring reliable performance across different network configurations.

Referring back to FIG. 1, the topic modeling component 110 includes the coherence metric module 106 which is configured to calculate an optimal number of topics, such as N topics. A coherence metric is a measure used to evaluate, for example, how well the words within a topic are semantically related to each other, assessing how interpretable and meaningful a topic is by looking at the similarity between its top words; a high coherence score indicates that the words within a topic are closely related and make sense together, while a low score suggests a less coherent, confusing topic. In the present disclosure, the coherence metric module 106 may not evaluate whether topic models follow interpretable logic but rather evaluate which topic models can reduce data dimensionality for further analysis and processing. The topic modeling component 110 is configured to reduce the dimensionality of data by using various examples, which will be utilized in prompts for creating parsers. N topics are provided to the topic modelling module 107, which uses Latent Dirichlet Allocation (LDA) algorithm to determine how many different data examples with different formats are available. In the context of the LDA algorithm, the coherence metric helps users to select an optimal number of topics (i.e., N topics) for the LDA model by comparing different topic configurations based on coherence scores of each topic model.

By way of example only, about three to four topic models may be considered for simpler network device commands and twenty or more topic models may be considered for complex commands. As another example, the LDA topic modeling algorithm may identify a single representative data sample for each topic. This leads to categorizing the raw data 104 into topics and selecting one network command output that best represents each topic's characteristics in the topic allocation module 108. This ensures that one device with a particular format is retained to represent all possible formats in the entire sample. Additionally or alternatively, all output with a topic may be similar and selecting one network command output can be randomly done. The random selection may be based on assumption of similarity among outputs within each topic. A large amount of data is filtered based on topic modeling, extracting only one single device per topic, which includes selecting one representative data sample per device category identified by the topic modeling module 107. Each topic is uniquely represented, capturing diverse data formats while reducing redundancy.

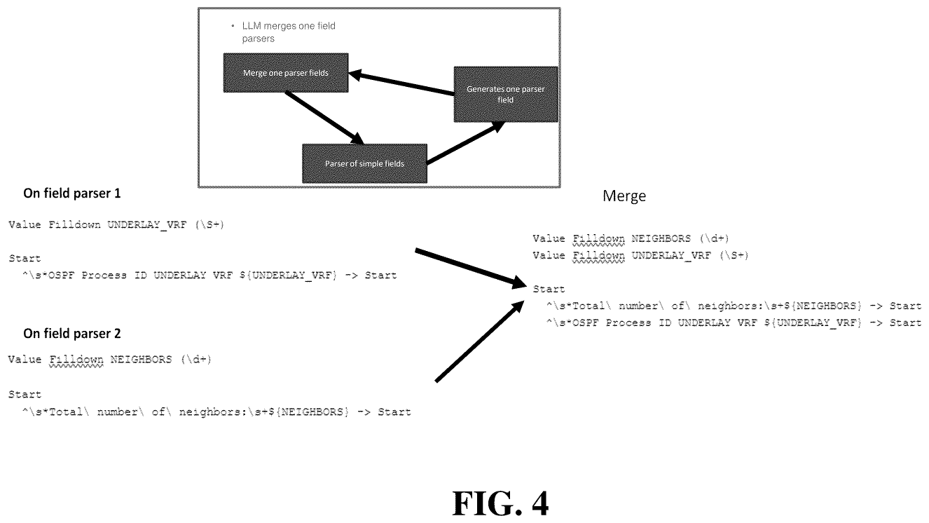

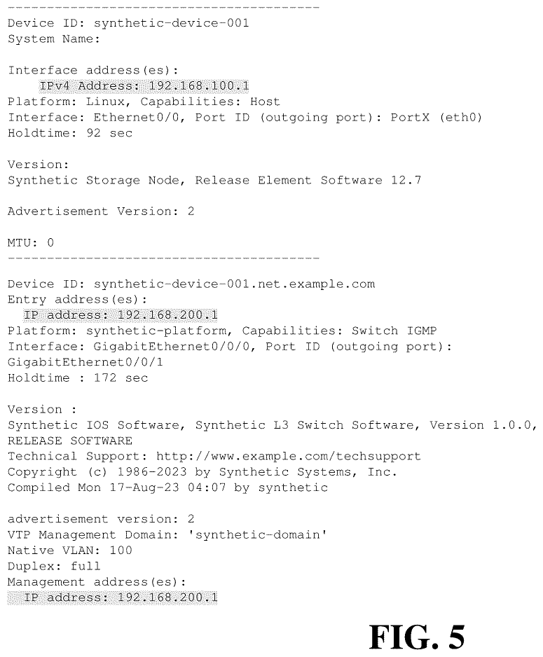

Once the raw data 104 and the topic models are prepared and allocated, a filtering component 112 is configured to filter the processed raw data into one data sample per topic. Then fields are categorized based on a difficulty of extraction with a field categorization component 114. By way of example, fields that appear in different places for different configurations or inside tables are considered difficult to extract. Conversely, fields that are consistently located are considered simple. FIG. 4 depicts non-limiting examples of simple fields along with one field parsers in accordance with various embodiments described herein. FIG. 5 depicts non-limiting examples of complex fields in accordance with various embodiments described herein. In FIG. 5, an “IP address” field in “show cdp neighbors detail” for two different topics of raw data corresponds to a complex field.

Then an API call is generated for a large language model (LLM) (i.e., an LLM API 130) to extract all of fields. The LLM API 130 is used to extract all of fields. Currently available large language models can be used to extract the fields and the present disclosure is not limited to a particular LLM as long as LLMs facilitate and support extracting fields from the filtered data. By way of example only, prompts to extract fields are as follows:
System prompt=“You are an AI language model trained to generate TextFSM parsers and you are a specialist in networking, specifically in XYZ routers.”
User_prompt=“The task is to extract all the important fields of the “show ip ospf neighbors vrf all” command.

Please follow these guidelines:
1) The output fields must be in a python list and nothing else. No other comment must appear.
2) Avoid duplication based on capital letters or spaces.
3) Do not write a parser.
4) Separate the output into two lists where one list must include the fields of the table inside the raw data and the other list all the rest of the fields.
5) Take into account the following data “XYZ” to do the selection.

In one or more embodiments, to separate fields, the filtered data (e.g., network device command outputs), is provided to the LLM API 130. For instance, the filtered data include both simple and complex fields that need to be categorized. The LLM API 130 analyzes the filtered data to identify patterns and structures within the filtered data, recognizing fields based on their consistency and location within the filtered data. For simple fields, the LLM API identifies those that consistently appear in the same location across different outputs, making them straightforward to extract due to their predictable positioning. For the complex fields, the API identifies those that vary in location or appear within tables and different configurations, marking them as difficult to extract because they require more sophisticated parsing logic. In some embodiments, users may provide some examples of complex parsers in light of complexity of the complex fields in the filtered data.

The LLM API 130 outputs a categorized list of fields, distinguishing between simple and complex ones. This simple v. complex fields categorization helps in developing targeted parsing strategies for each type of field. By leveraging the LLM API 130's ability to understand and process text, the system 100 can efficiently separate fields based on their extraction difficulty, streamlining a parser development process. As depicted in FIG. 1, simple fields are provided to generate a simple parser 160 and complex fields are provided to generate complex parsers 140. A universal parser 150 including both the complex parsers 140 and the simpler parser 160 is generated accordingly.

FIG. 4 illustrates non-limiting examples of single parsers in accordance with various embodiments described herein. FIG. 4 depicts generating a simple field parser 1 for filtered raw data and generating a simple field parser 2 for another filtered raw data. FIG. 4 further depicts generating a merged parser based on the simple parsers 1 and 2. As depicted in FIG. 1 and FIG. 4, an iterative extraction algorithm for simple fields is performed in the simpler parser 160. The iterative extraction algorithm is operable to generate the simple parser 160 for simple fields 112. As depicted in FIG. 4, this iterative algorithm merges parsers for simple fields iteratively to generate the simple parser 160. As shown in FIGS. 1 and 4, the interactive extraction algorithm is performed to generate single-field parsers (164), merge the single-field parsers to create a larger parser (162), and complete a parser of simple fields (166). This extraction and merging process may be iteratively performed to result in the simple parser for simple fields.

In one or more embodiments, the simple parser generation process involves a Large Language Model (LLM) to merge these individual one-field parsers. The LLM combines the parsers iteratively, ensuring that each field is accurately extracted and integrated into a single, cohesive parser. In a next iteration, the merged parser with the two fields will be merged with another filed to get a three-field parser, although not shown in FIG. 4. This process is interactively performed with respect to the filtered raw data based on the topic modelling process. The merging process is depicted in FIG. 4, showing how the individual parsers are combined to form the merged parser that can handle multiple fields simultaneously, by way of example only. The merged parser uses the combined patterns to extract both fields from the filtered raw data, ensuring that the structured data output includes all relevant information. This iterative merging process simplifies the task for the LLM, allowing it to handle the complexity of multiple fields while maintaining accuracy and efficiency in data extraction.

Referring back to FIG. 1, in one or more embodiments, the system 100 is further configured to generate complex parsers for complex field parsing 140. In some embodiments, the complex parsers may be subject to few shot learning generated from user inputs if the complexity of these fields and/or potential certain limit of the LLM API 130 in generating the complex parsers. A final parser merging is performed by merging the parsers for both simple and complex fields to obtain the final universal parser 150. The final universal parser 150 is provided to the data storage and management system 102. In some embodiments, relevant metrics can be evaluated to determine performance and accuracy of the final universal parser 150.

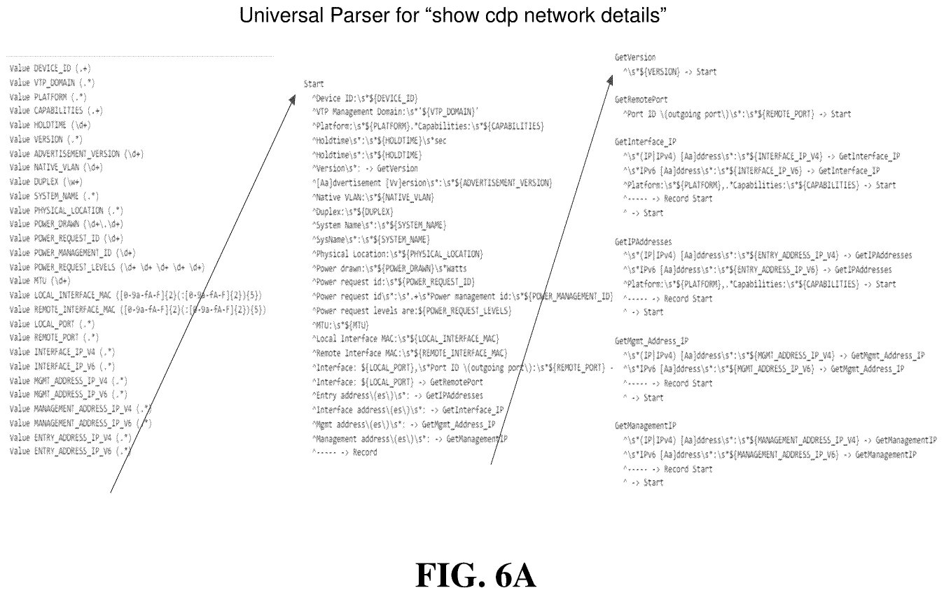

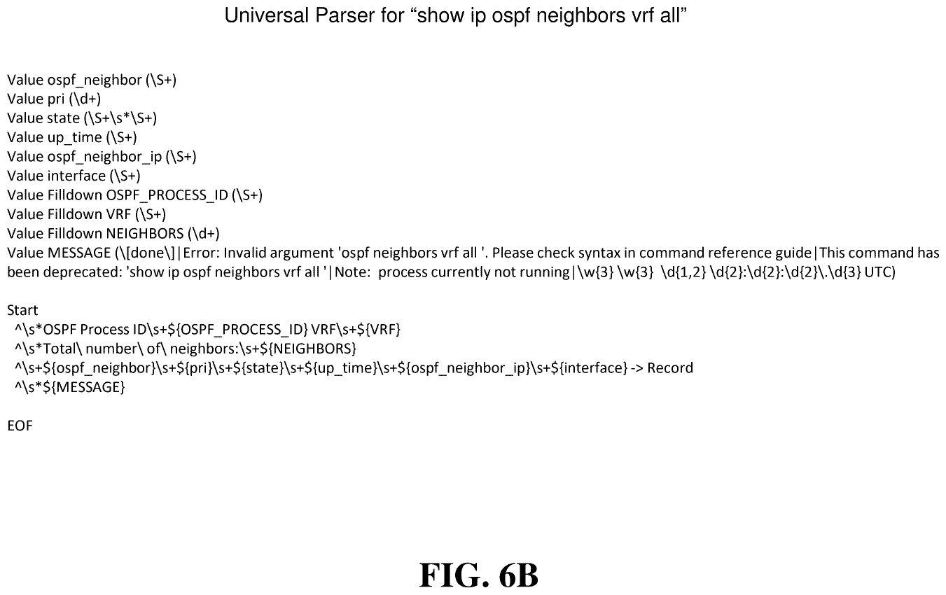

FIG. 6A illustrates one example of a universal parser in accordance with various aspects described herein. FIG. 6A illustrates a universal parser designed for the “show cdp network details” command, showcasing the structure and components of the parser. FIG. 6A is divided into three main sections. The left section lists the various fields that the parser is designed to extract, such as DEVICE_ID, IPV4_ADDRESS, PLATFORM, CAPABILITIES, VERSION, and several others. Each field is associated with a specific pattern or regular expression that matches the corresponding data in the raw output. The middle section of FIG. 6A presents the main body of the universal parser 150, detailing a sequence of operations and conditions used to identify and extract specified fields from the raw data. It includes a starting point of the universal parser 150, various states, and transitions between these states based on the patterns matched. The right section further breaks down specific sub-routines or functions within the universal parser 150, such as GetVersion, GetInterface, and GetManagementIP, which handle the extraction of more complex or nested fields. This comprehensive structure allows the universal parser 150 to accurately and efficiently convert unstructured command output into structured data, facilitating automated network management and analysis.

FIG. 6B illustrates another example of a universal parser in accordance with various aspects described herein. FIG. 6B illustrates a universal parser designed for the “show ip ospf neighbors vrf all” command, detailing the structure and components necessary for parsing the command output. The universal parser is defined using TextFSM syntax, which includes various fields such as ospf_neighbor, pri, state, up_time, ospf_neighbor_ip, interface, OSPF_PROCESS_ID, VRF, NEIGHBORS, and MESSAGE. Each field is associated with a specific pattern or regular expression that matches the corresponding data in the raw output, allowing for accurate extraction of relevant information.

The parser begins with the “Start” state, which includes patterns to match the OSPF Process ID, VRF, and the total number of neighbors. It then proceeds to match and extract the details of each OSPF neighbor, including their priority, state, uptime, IP address, and interface. Additionally, the universal parser is designed to capture any messages related to errors or deprecated network device commands. The comprehensive structure of this universal parser ensures that it can accurately and efficiently convert unstructured command output into structured data, facilitating automated network management and analysis along with additional processing.

Referring back to FIG. 1, the universal parser 150 for both simple and complex fields are merged to obtain the final universal parser. The universal parser 150 is tested to find errors in the raw data. In some embodiments, an existing error-checking module that is already operational and currently in use can be used. This error-checking module effectively validates the parser's output by comparing it against expected results, ensuring accuracy and reliability. If test results show more than 80% of devices without errors, the universal parser 150 may be approved for that particular command. Then the universal parser 150 is posted in the data storage and management system 102 once the universal parser 150 gives a correct result based on the metrics calculation. If the universal parser fails to achieve a threshold rate such as 80% success rate, a follow-up analysis to identify issues may be performed. Based on this analysis, the universal parser may be manually adjusted if an error is minor. Alternatively, if the error is more significant, the prompt to the LLM API 130 may be modified and the few-shot learning may be enhanced to address incorrect parts, and then run the pipeline again.

In the above-described embodiments, universal parsers from the different commands are designed to be applied in the following use cases. By way of example only, in network inventory management, universal parsers may automatically gather and parse detailed information about connected devices. This enables enterprises to maintain an up-to-date inventory of network devices. In network topology mapping, universal parsers may be used to generate accurate network topology maps by understanding device interconnections, aid in planning, troubleshooting, and optimizing network configurations.

In configuration audits and compliance applications, universal parsers may be used to perform regular audits to ensure compliance with organizational policies, and identify discrepancies and unauthorized changes in the network. In troubleshooting and diagnostics applications, universal parsers may be used to quickly diagnose network issues by identifying connectivity problems and misconfigurations. Universal parsers may be further used to provide detailed insights into device relationships and interface statuses. Universal parsers may be used to perform automated reporting. By applying the universal parser tool in these use cases and steps, network technicians and administrators can enhance productivity, improve accuracy, and reduce manual effort in network management tasks.

By using universal parsers, a scalable and efficient graph database platform may be implemented, which enables organizations to leverage the power of interconnected data, supporting applications ranging from fraud detection to AI and machine learning. The graph database platform can be used to support network devices interconnected within organizations where network device command outputs can be parsed with universal parsers and presented as structured data for automation. Based on the structured data, the graph database platform enables organizations to determine, process and interpret complex relationships of network devices within massive datasets.

By way of example only, a large enterprise managing a network of 10,000 routers from 50 different vendors, each with unique command syntaxes and output formats, resulting in a vast number of different command outputs. Traditionally, this would require a fragmented approach with custom parsers for each vendor, leading to inefficiencies and errors. The universal parser using TextFSM in the above described embodiments can standardize the parsing process across all devices, ensuring consistent data structures and reducing human errors. This automation enhances network reliability by allowing for automated configuration updates and repairs, freeing up valuable human resources for strategic tasks. The universal parser's scalability enables it to efficiently handle vast data volumes, reducing computational overhead and processing time, while also providing significant cost savings by eliminating the need for multiple parsers.

Additionally, the universal parser's ability to rapidly adapt to new commands ensures continuous network operations in dynamic environments. The structured data produced can be integrated into a graph database for advanced analysis, supporting applications like network monitoring and capacity planning. This comprehensive solution not only optimizes current network management processes but also positions organizations to seamlessly adapt to future technological advancements.

A large enterprise with thousands of network devices spread across multiple locations. Traditionally, maintaining an accurate inventory of these devices requires manual updates and is prone to errors. By using the universal parser described in the above embodiments, command outputs from various devices are automatically converted into structured data, which is then used to update the inventory in real-time. Network administrators have access to the most current information about device types, configurations, and statuses, enabling more efficient network management and planning.

In a complex network environment, understanding the interconnections between devices is crucial for troubleshooting and optimization. The universal parser described in the above embodiments processes command outputs to extract information about device connections and relationships. This structured data is then used to generate dynamic network topology maps that visually represent the network's structure. These maps help network administrators quickly identify potential bottlenecks, optimize traffic flow, and plan for future expansions. By automating the creation of topology maps, the universal parser may reduce the time and effort required for network analysis and enhances the accuracy of the visualizations.

In large corporate networks, diagnosing connectivity issues and detecting misconfigurations may significantly impact operations. The universal parser described in the above embodiments streamlines these processes by converting command outputs from network devices into structured data. For instance, when sudden connectivity issues arise, the parser extracts data related to device status, link health, and connection paths, allowing network administrators to quickly identify the source of the problem, such as a failed link or an offline device. This rapid identification enables swift corrective actions, minimizing downtime and restoring network functionality efficiently. Additionally, the universal parser in the above described embodiments aids in detecting misconfigurations by analyzing configuration details against predefined standards. Deviations or errors are automatically flagged, alerting administrators to potential issues before they escalate. This proactive approach not only enhances network reliability and security but also supports efficient troubleshooting and optimization efforts, ultimately improving overall network management.

Universal parsers, as described in the above embodiments, are designed to handle the variability and complexity of network command outputs from a wide range of network devices. By employing advanced AI techniques, such as large language models, these universal parsers may automatically interpret and convert unstructured command outputs into structured data formats. Accordingly, different network command outputs across various device families and manufacturers can be parsed, each of which may have unique command syntax and output structures.

Once the command outputs are parsed into a structured format, the data can be effectively utilized to build a graph database platform. In this context, the structured data serves as the foundation for mapping the relationships and interconnections between network devices. The graph database can represent devices as nodes and their interconnections as edges, capturing the topology and configuration of the network in a dynamic and scalable manner. This representation allows for advanced querying and analysis, enabling network administrators to visualize network topology, perform impact analysis, and optimize network configurations. Additionally, the graph database can support applications such as network inventory management, troubleshooting, and automated reporting, providing a comprehensive view of the network's operational state and facilitating efficient network management.

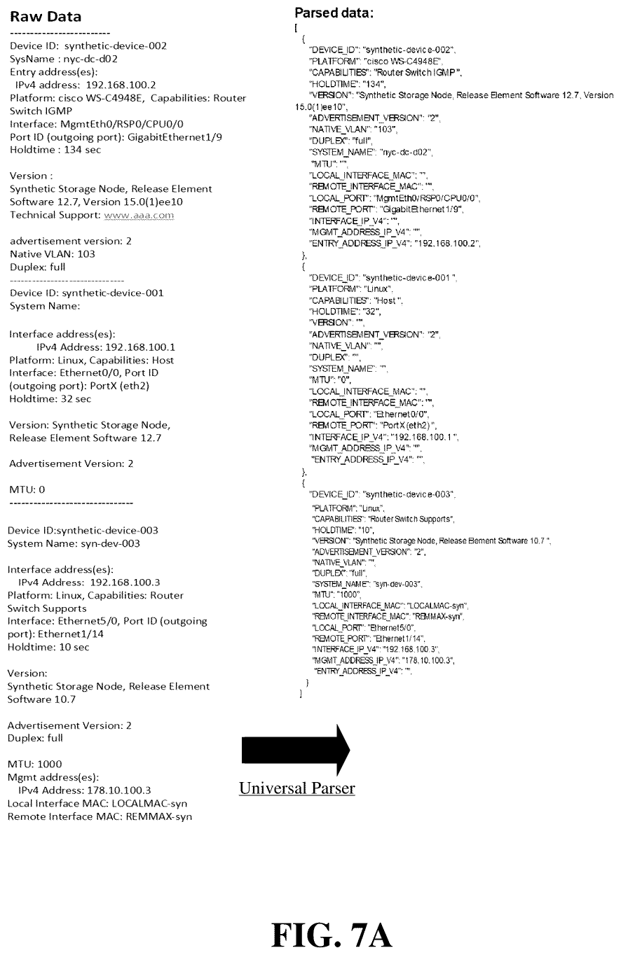

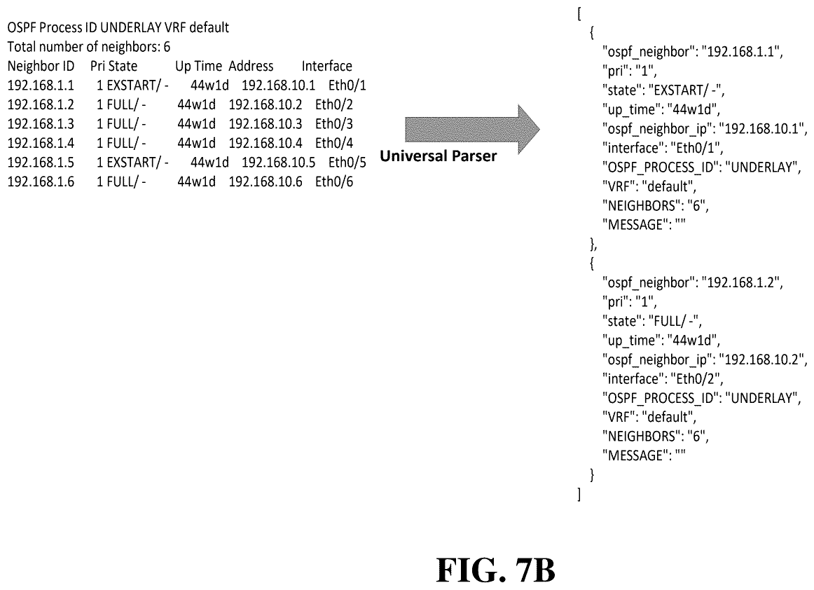

FIG. 7A illustrates example, non-limiting embodiments of parsing with a universal parser in accordance with various aspects described. FIG. 7A illustrates application of a universal parser to transform unstructured network device data into a structured format. FIG. 7A depicts an example with three synthetic device raw data sets and their corresponding parsed data. The fields present in these three examples are considered and other fields may appear based on different device types that are not included here. The universal parser may incorporate those fields into the parsed data (list of JSON) with empty values if they are not present in these devices. On the left side of FIG. 7A, raw data from a network device command is displayed, including fields such as Device ID, System Name, Interface addresses, Platform, Capabilities, Interface, Holdtime, and Version. This data is typically presented in a semi-structured text format, which can be challenging to process and analyze manually. The universal parser processes this raw data by applying predefined patterns and rules to extract relevant information. The universal parser converts the unstructured text into a structured format, as shown on the right side of FIG. 7A. The structured data includes key-value pairs for each extracted field, such as “device_id,” “ipv4_address,” “platform,” and “interface.”

As depicted in FIG. 7A, automating an extraction process becomes much simpler when extracting data from a list of JSON objects. This is because the data fields consistently have the same name and position, ensuring uniformity. Additionally, if a field does not exist for a particular device, the value for that field will be empty, allowing for seamless data handling. This transformation facilitates automated network management tasks by providing a consistent and machine-readable format, enabling easier integration with other systems and tools for further analysis and reporting. Another advantage is that this uniform structure facilitates easier integration with other systems and tools, enhancing data processing efficiency and reducing the likelihood of errors.

FIG. 7B illustrates example, non-limiting embodiments of another parsing with a universal parser in accordance with various aspects described herein. FIG. 7B demonstrates the use of a universal parser to convert unstructured network command outputs into a structured data format. The left side of FIG. 7B presents raw output from a network device command, specifically the “show ip ospf neighbors vrf all” command. This output includes details such as Neighbor ID, Priority, State, Up Time, Address, and Interface, which are typically displayed in a tabular text format that can be difficult to process manually. The universal parser is designed to interpret this raw data by applying specific patterns and rules to extract the necessary information. The universal parser processes the text and outputs it in a structured format, depicted on the right side of FIG. 7B. This structured data format includes key-value pairs for each field, such as “ospf_neighbor,” “pri,” “state,” “up_time,” “ospf_neighbor_ip,” and “interface.” By transforming the unstructured text into a structured format, the universal parser enables automated network management and analysis, allowing for seamless integration with other systems and tools for enhanced operational efficiency.

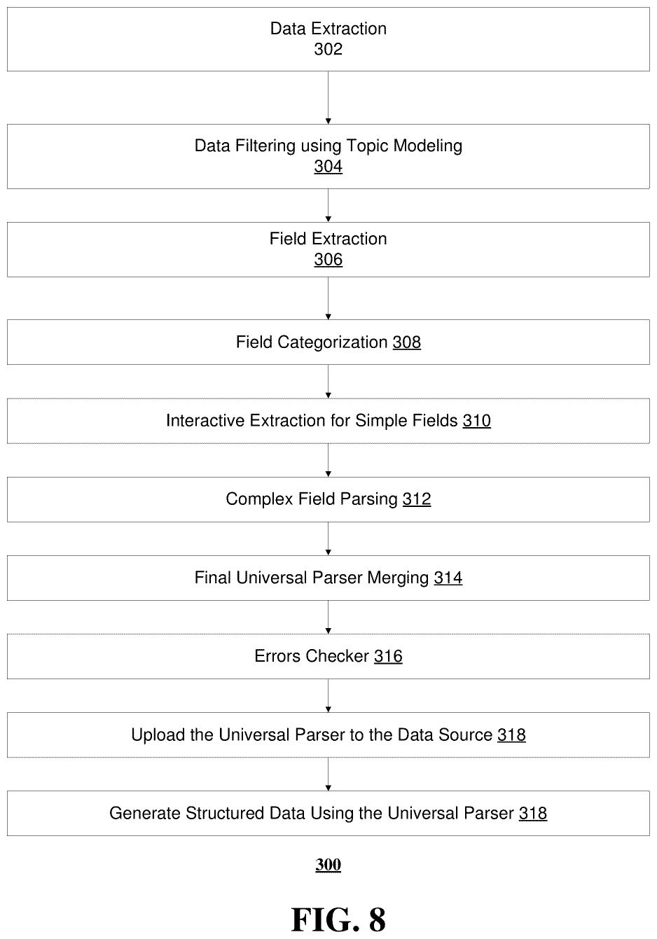

FIG. 8 illustrates a method 300 for generating structured data using a universal parser in accordance with various aspects described herein. The method 300 is configured to generate structured data using a universal parser, detailing each step involved in the process. The method 300 includes a data extraction step (302), a data filtering step using topic modeling (304), a field extraction step (306), a field categorization step (308), an interactive extraction step for simple fields (310), a complex field parsing step (312), a final universal parser merging step (314), an error checking step (316), a step of uploading the universal parser to the data source (318), a step of generating structured data using the universal parser (320). Each step of the method 300 in FIG. 8 is described in detail below.

In various embodiments, the data extraction step (Step 302) involves retrieving raw data from a data storage system, which contains outputs from various network device commands. This raw data is typically unstructured and includes diverse command outputs from different network devices. The extraction process is facilitated by an authenticated API session, which involves setting up authentication, initializing a session, and making API requests to obtain the necessary data. The extracted data serves as the foundational input for subsequent processing steps, where it will be filtered, categorized, and parsed to generate structured data. This step ensures that the raw data is accurately and efficiently gathered, providing a comprehensive dataset for the universal parser to process and transform into a structured format.

This raw data is then subjected to data filtering using topic modeling (Step 304), which organizes and categorizes the data based on specific topics to ensure relevance and manageability. The data filtering using topic modeling (Step 304) utilizes a topic model algorithm, such as Latent Dirichlet Allocation (LDA), to decompose the raw data into distinct topics based on the content and structure of the network device command outputs. By calculating an optimal number of topics using a coherence metric, data dimensionality can be effectively reduced and the method 300 may focus on the most relevant data samples. The topic modeling process ensures that one representative data sample per topic is retained, capturing diverse data formats while minimizing redundancy. This filtering step (Step 304) leads to streamlining the subsequent field extraction (Step 306) and parser generation processes, as it provides a more manageable and organized dataset for further analysis.

Following the filtering process (Step 304), the field extraction (Step 306) is performed to identify and extract relevant fields from the filtered data. In the filed extraction process (Step 306), relevant fields are identified and extracted from the filtered data obtained in the previous step. This field extraction process (Step 306) leverages a large language model (LLM) to analyze the filtered data and recognize patterns and structures within the network device command outputs. The LLM is prompted to identify and extract specific fields, in order to transform the unstructured data into a structured format. By accurately extracting these fields, the fields are categorized into simple and complex fields in subsequent steps (Step 308). In the field extraction process (Step 306), fields information is captured, enabling the creation of effective parsers that can handle the variability and complexity of network command outputs.

These extracted fields are then categorized into simple and complex fields based on the difficulty of extraction in the field categorization step (Step 308). Simple fields are those that consistently appear in the same location across different outputs, making them straightforward to extract due to their predictable positioning. Conversely, complex fields are those that vary in location or appear within tables and different configurations, requiring more sophisticated parsing logic. The categorization process leverages the capabilities of a large language model (LLM) to analyze the filtered data, identify patterns, and distinguish between simple and complex fields. This step streamlines the parser development process by allowing targeted parsing strategies to be developed for each field type, ensuring efficient and accurate data extraction.

For simple fields, an interactive extraction process (Step 310) is applied, which iteratively generates parsers for these fields, ensuring that each field is accurately captured. Step 310 involves the interactive extraction for simple fields, where an iterative algorithm is applied to generate parsers for these fields. This process uses the filtered data as context and employs a large language model (LLM) to create individual one-field parsers for each simple field identified in the previous categorization step. The algorithm iteratively merges these one-field parsers, gradually building a comprehensive parser that can handle multiple simple fields simultaneously. In the first iteration, a parser is created for a single field, and in subsequent iterations, additional fields are merged into the parser. This iterative approach simplifies the task for the LLM, allowing it to manage the complexity of multiple fields while maintaining accuracy and efficiency in data extraction. The result is a complete parser for simple fields, which forms a part of the universal parser used to transform unstructured data into a structured format.

In FIG. 8, a complex field parsing (Step 312) performs the extraction of fields classified as complex due to their variability in location or appearance within tables and different configurations. This step 312 may be supplemented with manual intervention due to the inherent complexity of these fields. The large language model (LLM) plays a role in generating parsers for complex fields, leveraging advanced AI capabilities to interpret and handle the diverse structures present in the raw data. In some cases, few-shot learning techniques are employed to enhance the model's ability to generalize from limited examples, improving the accuracy and robustness of the parsers.

An errors checker (Step 316) is then employed to validate the accuracy and performance of the final universal parser. If the parser meets the required standards, it is uploaded to the data source in the upload the universal parser to the data source step (Step 318), making it available for use. Finally, in the generate structured data using the universal parser step (Step 318), the universal parser is used to generate structured data from the raw data, transforming unstructured information into a structured format that can be utilized for various applications, such as network management, configuration audits, and automated reporting. The entire process, as depicted in FIG. 8, highlights a systematic approach to data transformation, leveraging advanced AI/ML techniques and iterative parsing methods to achieve high accuracy and efficiency.

While for purposes of simplicity of explanation, the respective processes are shown and described as a series of blocks in FIG. 8, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. Note, one or more blocks can be performed in response to one or more other blocks. Further, some portions of embodiments can be combined with portions of other embodiments.

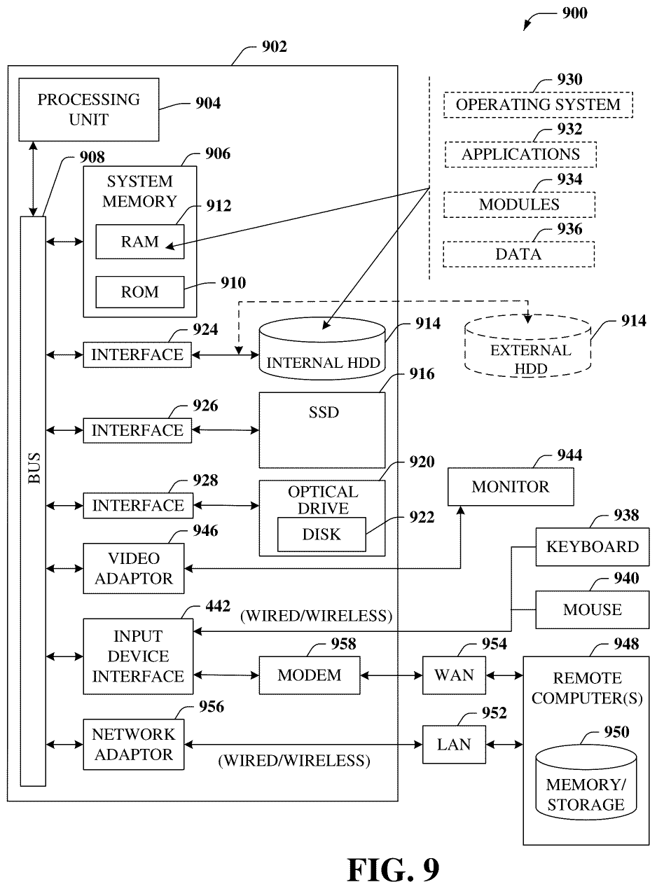

Turning now to FIG. 9, there is illustrated a block diagram of a computing environment in accordance with various aspects described herein. In order to provide additional context for various embodiments of the embodiments described herein, FIG. 9 and the following discussion are intended to provide a brief, general description of a suitable computing environment 900 in which the various embodiments of the subject disclosure can be implemented. In particular, the computing environment 900 can be used in computing device described herein. Each of these devices can be implemented via computer-executable instructions that can run on one or more computers, and/or in combination with other program modules and/or as a combination of hardware and software. For example, computing environment 900 can facilitate in whole or in part continuing processing of a service by a server in response to a request from a client computing device as a blocking call after an initial timeout or converting the blocking call to a non-blocking call after an initial timeout. Further, each of the server 100c, client computing device 100e, client computing device 100h, client computing device 200a, server 200b, client computing device 210a, and server 210b can comprise computing environment 900.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory”herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 9, the example environment can comprise a computer 902, the computer 902 comprising a processing unit 904, a system memory 906 and a system bus 908. The system bus 908 couples system components including, but not limited to, the system memory 906 to the processing unit 904. The processing unit 904 can be any of various commercially available processors. Dual microprocessors and other multiprocessor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 comprises ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also comprise a high-speed RAM such as static RAM for caching data.

The computer 902 further comprises an internal hard disk drive (HDD) 914 (e.g., EIDE, SATA), which internal HDD 914 can also be configured for external use in a suitable chassis (not shown), a solid state disk drive (SSD) 916, and an optical disk drive 920, (e.g., reading a CD-ROM disk 922 or, to read from or write to other high-capacity optical media such as the DVD). The HDD 914, the SSD 916 and optical disk drive 920 can be connected to the system bus 908 by a hard disk drive interface 924, a magnetic disk drive interface 926 and an optical drive interface 928, respectively. The hard disk drive interface 924 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 912, comprising an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

A user can enter commands and information into the computer 902 through one or more wired/wireless input devices, e.g., a keyboard 938 and a pointing device, such as a mouse 940. Other input devices (not shown) can comprise a microphone, an infrared (IR) remote control, a joystick, a game pad, a stylus pen, touch screen or the like. These and other input devices are often connected to the processing unit 904 through an input device interface 942 that can be coupled to the system bus 908, but can be connected by other interfaces, such as a parallel port, an IEEE 1394 serial port, a game port, a universal serial bus (USB) port, an IR interface, etc.

A monitor 944 or other type of display device can be also connected to the system bus 908 via an interface, such as a video adapter 946. It will also be appreciated that in alternative embodiments, a monitor 944 can also be any display device (e.g., another computer having a display, a smart phone, a tablet computer, etc.) for receiving display information associated with computer 902 via any communication means, including via the Internet and cloud-based networks. In addition to the monitor 944, a computer typically comprises other peripheral output devices (not shown), such as speakers, printers, etc.

The computer 902 can operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically comprises many or all of the elements described relative to the computer 902, although, for purposes of brevity, only a remote memory/storage device 950 is illustrated. The logical connections depicted comprise wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the LAN 952 through a wired and/or wireless communication network interface or adapter 956. The adapter 956 can facilitate wired or wireless communication to the LAN 952, which can also comprise a wireless AP disposed thereon for communicating with the adapter 956.

When used in a WAN networking environment, the computer 902 can comprise a modem 958 or can be connected to a communications server on the WAN 954 or has other means for establishing communications over the WAN 954, such as by way of the Internet. The modem 958, which can be internal or external and a wired or wireless device, can be connected to the system bus 908 via the input device interface 942. In a networked environment, program modules depicted relative to the computer 902 or portions thereof, can be stored in the remote memory/storage device 950. It will be appreciated that the network connections shown are example and other means of establishing a communications link between the computers can be used.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

1. A non-transitory machine-readable medium, comprising executable instructions that, when executed by a client computing device including a processor, facilitate performance of operations, the operations comprising:
extracting raw data from a data storage, wherein the raw data includes a first plurality of network device command outputs for a target network device command for different network devices, wherein a first portion of the first plurality of network device command outputs are in a first command syntax and in a first output format, and wherein a second portion of the first plurality of network device command outputs are in a second syntax and in a second output format;
filtering the raw data using a topic model algorithm, resulting in filtered raw data;
extracting, from the filtered raw data, a plurality of fields using a generative artificial intelligence (Gen-AI) engine, resulting in extracted plurality of fields;
classifying the extracted plurality of fields into a first classification and a second classification, wherein the first classification corresponds to a simple field and the second classification corresponds to a complex field;
using the Gen-AI engine, generating, a group of one field parsers for the simple field and merging each of the group of one field parsers, resulting in a merged single field parser,
using the Gen-AI engine, generating complex parsers to parse the complex field utilizing a machine learning model, wherein the machine learning model is trained using few-shot learning;
outputting an universal parser based on the merged single field parser and the complex parsers;
using the universal parser, generating structured data from the raw data to be used in a network process by the different network devices;
identifying that the structured data includes a second plurality of network device command outputs, wherein each of the second plurality of network device command outputs are in a third command syntax and in a third output format;
generating the target network device command associated with configuration updates of the different network devices based on the second plurality of network device command outputs; and
automating configuration updates of the different network devices utilizing the target network device command.

2. The non-transitory machine-readable medium of claim 1, wherein the operations further comprise:
validating the universal parser by performing an error check resulting in a validated universal parser; and
loading the validated universal parser into the data storage for subsequent use in generating structured data from a network device command output.

3. The non-transitory machine-readable medium of claim 2, wherein the topic model algorithm further comprises a coherence metric based Latent Dirichlet Allocation (LDA) algorithm to reduce the raw data based on a predetermined number of topics.

4. The non-transitory machine-readable medium of claim 1, wherein the filtering the raw data using the topic model algorithm further comprise determining an optimal number of topics related to the raw data for the target network device command using a coherence metric.

5. The non-transitory machine-readable medium of claim 4, wherein the filtering the raw data using the topic model algorithm further comprise:
selecting a single network command output that represents characteristics of the optimal number of topics with respect to each of the different network devices.

6. The non-transitory machine-readable medium of claim 1, wherein the using of the Gen-AI engine further comprises using a large language model (LLM) prompted to employ a TextFSM function for generating parsers, wherein the LLM is configured to interpret a structure of network device command outputs and create corresponding parsing templates.

7. The non-transitory machine-readable medium of claim 1, wherein the using the structured data generated using the universal parser in the network process by the different network devices further comprises:
maintaining an up-to-date inventory of network devices; and
generating network topology maps based on device interconnections included in the structured data.

8. The non-transitory machine-readable medium of claim 1, wherein the using the structured data generated using the universal parser in the network process by the different network devices further comprises diagnosing network issues by identifying connectivity and misconfigurations.

9. A method, comprising:
extracting, by a processing system including a processor, textual data from a data storage, wherein the textual data includes a first plurality of network device command outputs for a selected network device command with respect to different network devices, wherein a first portion of the first plurality of network device command outputs are in a first command syntax and in a first output format, and wherein a second portion of the first plurality of network device command outputs are in a second syntax and in a second output format;
filtering, by the processing system, the textual data using a topic model algorithm to organize and categorize the textual data based on specific topics, resulting in filtered textual data;
extracting, by the processing system, a plurality of fields from the filtered textual data using a generative artificial intelligence (Gen-AI) engine, resulting in extracted plurality of fields;
classifying, by the processing system, the extracted plurality of fields into a simple field and a complex field;
generating, by the processing system, a simple parser for the simple field using the Gen-AI engine;
generating, by the processing system, a complex parser for the complex field utilizing a machine learning model, wherein the machine learning model is training using few-shot learning; and
generating, by the processing system, a universal parser by combining the simple parser and the complex parser;
generating, by the processing system, structured data using the universal parser for using the structured data in a network process by the different network devices;
identifying, by the processing system, that the structured data includes a second plurality of network device command outputs, wherein each of the second plurality of network device command outputs are in a third command syntax and in a third output format;
generating, by the processing system, the selected network device command associated with configuration updates of the different network devices based on the second plurality of network device command outputs; and
automating, by the processing system, configuration updates of the different network devices utilizing selected target network device command.

10. The method of claim 9, wherein the generating the simple parser further comprises:
iteratively generating a single-field parser resulting in a group of single-field parsers;
iteratively merging the group of single-field parsers to create merged single-field parsers; and
completing the generating of the simple parser based on the merged single-field parsers.

11. The method of claim 9, further comprising:
validating, by the processing system, the universal parser by checking for errors after parsing the textual data to meet a required accuracy threshold resulting in a validated universal parser; and
loading, by the processing system, the validated universal parser into the data storage.

12. The method of claim 9, wherein the filtering the textual data further comprises:
for the selected network device command, calculating an optimal number of topics using a coherence metric; and
selecting a single network command output that represents characteristics of the optimal number of topics with respect to each of the different network devices using a Latent Dirichlet Allocation (LDA) algorithm.

13. The method of claim 9, wherein the using the structured data generated using the universal parser in the network process by the different network devices further comprises generating network topology maps based on device interconnections included in structured data generated by using the universal parser, thereby aiding in network planning and optimization.

14. The method of claim 9, wherein the using the structured data generated using the universal parser in the network process by the different network devices further comprises generating a graph database platform, wherein structured data generated using the universal parser are utilized to represent the different network devices as nodes and interconnections thereof as edges, enabling querying and analysis of network topology and configuration.

15. The method of claim 9, further comprising continuously running, by the processing system, a pipeline operable to extract the textual data, transform the textual data into structured data using the universal parser, and load the textual data and the universal parser into the data storage.

16. A system, comprising:
a processing system including a processor, and
a memory that stores executable instructions that, when executed by the processing system, facilitate performance of operations, the operations comprising:
extracting raw data from a data storage, wherein the raw data includes a first plurality of network device command outputs for a target network device command with respect to different network devices, wherein a first portion of the first plurality of network device command outputs are in a first command syntax and in a first output format, and wherein a second portion of the first plurality of network device command outputs are in a second syntax and in a second output format;
filtering the raw data using a topic model algorithm, resulting in filtered raw data;
extracting a plurality of fields using a generative artificial intelligence (Gen-AI) engine from the filtered raw data, resulting in extracted plurality of fields;
classifying the extracted plurality of fields into a first classification and a second classification, wherein the first classification corresponds to a simple field and the second classification corresponds to a complex field;
using the Gen-AI engine, generating, a group of one field parsers for the simple field and merging each of the group of one field parsers, resulting in a merged single field parser,
using the Gen-AI engine, generating a complex parser to parse the complex field utilizing a machine learning model, wherein the machine learning model is trained using few-shot learning;
outputting an universal parser based on the merged single field parser and the complex parser; and
using the universal parser, generating structured data by converting the raw data for use in a network process by the different network devices;
identifying that the structured data includes a second plurality of network device command outputs, wherein each of the second plurality of network device command outputs are in a third command syntax and in a third output format;
generating the target network device command associated with configuration updates of the different network devices based on the second plurality of network device command outputs; and
automating configuration updates of the different network devices utilizing the target network device command.

17. The system of claim 16, wherein the filtering of the raw data comprises calculating an optimal number of topics using a coherence metric to organize and categorize the raw data.

18. The system of claim 16, wherein the using of the structured data by converting the raw data using the universal parser further comprises generating network topology maps based on device interconnections included in the structured data, thereby aiding in network planning and optimization.

19. The system of claim 16, wherein the using of the structured data by converting the raw data using the universal parser further comprises generating a graph database platform, wherein the structured data generated using the universal parser are utilized to represent the different network devices as nodes and interconnections thereof as edges, enabling querying and analysis of network topology and configuration.

20. The system of claim 16, wherein the using of the Gen-AI engine further comprises using a large language model (LLM) prompted to employ a TextFSM function for generating parsers, wherein the LLM is configured to interpret a structure of network device command outputs and create corresponding parsing templates.
